(19) United States
(12) Patent Application Publication
(10) Pub. No.: US 2012/0011057 A1
(43) Pub. Date: Jan. 12, 2012

(54) PUBLICATION SYSTEM INITIATED VALUE TRANSFER

(76) Inventors: Srinivasan Raman, Cupertino, CA (US); Manju Anand, Palo Alto, CA (US); Raphael Tsow, San Jose, CA (US); Scott Sharp, Sunnyvale, CA (US)

(21) Appl. No.: 12/832,861

(22) Filed: Jul. 8, 2010

(51) Int. Cl. G06Q 40/00; G06Q 20/00

(52) U.S. Cl. 705/38; 705/39

(57) ABSTRACT

A method and a system for publication system initiated value transfer are provided. Example embodiments may include a payment system receiving a request from a publication system to initiate transfer of a unit of value on behalf of a user. The publication system may operate as a publishing service for multiple providers of items. In response to the request, an example embodiment may include identifying a previously established agreement between the user and the payment system. The previously established agreement may authorize the publication system to initiate the transfer of the unit of value on behalf of the user by forwarding a transfer request to the payment system. An example embodiment includes facilitating transfer of the unit of value from an account associated with the user to a further account if the payment system determines further compliance with agreement terms.

### FIELD

The present disclosure relates generally to network-based transactions, and in various example embodiments, to a publication system initiated value transfer system.

### BACKGROUND

The Internet and other networks are commonly used to publish information. The published information may be directed to an offer of one or more items for sale or auction from a provider. A user may wish to obtain the item (e.g., an audio clip, goods, or services) in exchange for something of value to the provider (e.g., currency). Currently, transfers of value may be initiated by the user. Additionally, the transfer of value typically requires the user to perform multiple actions in order to complete the transfer, and to perform separate actions to transfer value for each provider.

### BRIEF DESCRIPTION OF THE DRAWINGS

Various ones of the appended drawings merely illustrate example embodiments of the present invention and cannot be considered as limiting its scope.

FIG. 1 is a block diagram illustrating an example embodiment of a network architecture of a system used allow a publication system initiated value transfer.

FIG. 2 is a block diagram illustrating an example embodiment of a publication system.

FIG. 3 is a block diagram illustrating an example embodiment of a payment system.

FIG. 4 is a high-level entity-relationship diagram, illustrating various tables that may be utilized by functional modules.

FIG. 5 is a high-level entity-relationship diagram, illustrating further tables that may be utilized by functional modules.

FIG. 6 is an example publication system agreement table.

FIG. 7 is an example value transfer system agreement table.

FIG. 8 is a flow diagram illustrating an example method for establishing an agreement for publication system initiated payments.

FIG. 9 is a flow diagram illustrating an example method for performing a publication system initiated payment at a publication system.

FIG. 10 is a flow diagram illustrating an example method for performing the publication system initiated payment at a payment system.

FIG. 11 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication and marketplace environment, the embodiments are given merely for clarity in disclosure. Thus, any type of electronic commerce or electronic business system and method, including various system architectures, may employ various embodiments of the gesture input system and method described herein and is considered as being within a scope of example embodiments. Each of a variety of example embodiments is discussed in detail, below.

In example embodiments, a user (e.g., buyer or consumer) may establish an agreement with a networked payment system to permit a publication system (e.g., network-based marketplace) to, under certain conditions, initiate payments to a seller on behalf of the user. The networked payment system may facilitate establishment of the agreement via one or more web pages used to communicate with the user over the Internet.

If the user subsequently indicates a desire to purchase an item presented within the network-based publication system, the network-based publication system may determine whether an agreement between the user and the networked payment system exists. If the agreement exists, terms of the agreement are reviewed to determine if all terms are met. If the terms of the agreement are met and risk assessment is satisfied, the network-based publication system may initiate the payment by transmitting a signal identifying the previously established agreement to the networked payment system. In example embodiments, the networked payment system confirms compliance with further agreement terms and risk assessment terms before transferring the user's payment to the seller.

In some example embodiments, the techniques introduced above may be used to allow a user to purchase and pay for an available item from an online marketplace's web page, with one click of a payment button on the web page. Alternatively or additionally, the techniques may allow the network-based publication system to automatically initiate a user's payment to a seller, for example, if a previously unavailable item later becomes available; if it is determined that a user who previously bid for an item has won an auction for the item; or if the user's previous offer for an item has been accepted.

It may be noted that a user may indicate a desire to make a payment from any networked device or network interfaced application. For example, a user may make payment from a mobile device such as a mobile phone, a web browser, and/or a widget hosted by a third party web server. Further example structures and methodologies for implementing the publication system initiated value transfers are provided in more detail below.

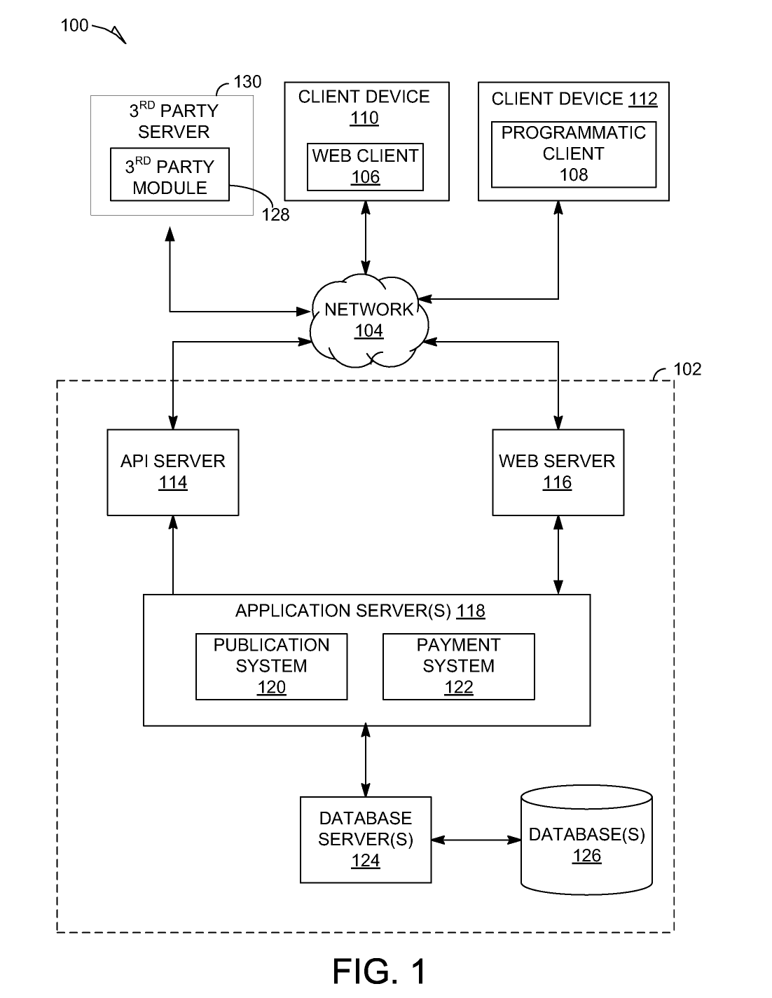

With reference to FIG. 1, an example embodiment of a high-level client-server-based network architecture 100 to provide publication system initiated value transfer functions is shown. A networked system 102, in an example form of a network-server-side functionality, is coupled via a network 104 (e.g., the Internet or Wide Area Network (WAN)) to one or more clients. FIG. 1 illustrates, for example, a web client 106 operating via a browser (e.g., such as the INTERNET EXPLORER® browser developed by Microsoft® Corporation of Redmond, Wash. State) and a programmatic client 108 executing on, respectively, client devices 110 and 112. The client devices 110 and 112 may include, for example, a mobile phone, a personal digital assistant (PDA), a gaming unit, a portable computing unit, or any other device capable of being communicatively coupled to the network 104.

Users may communicate with the networked system 102 through the client devices 110 and 112. For example, a user may use the web client 106 operating on the client device 110 to access various web pages via web interfaces. Similarly, the programmatic client 108 operating on the client device 112 may be employed to access the various services and functions provided by the networked system 102.

For some example embodiments, the web client 106 may be a web browser, and the programmatic client 108 may be a mobile application (e.g., eBay mobile application) to enable users to purchase and pay for items.

The network 104 over which the networked system 102 and the client devices 110 and 112 interact may be a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

An Application Program Interface (API) server 114 and a web server 116 are coupled to, and provide programmatic and web interfaces respectively to, one or more application servers 118. The application servers 118 host a publication system 120 (e.g., a marketplace system or commerce system) and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage databases or repositories 126.

The databases 126 comprise a collection of data including tables or agreements. The tables and agreements will be discussed in more detail below.

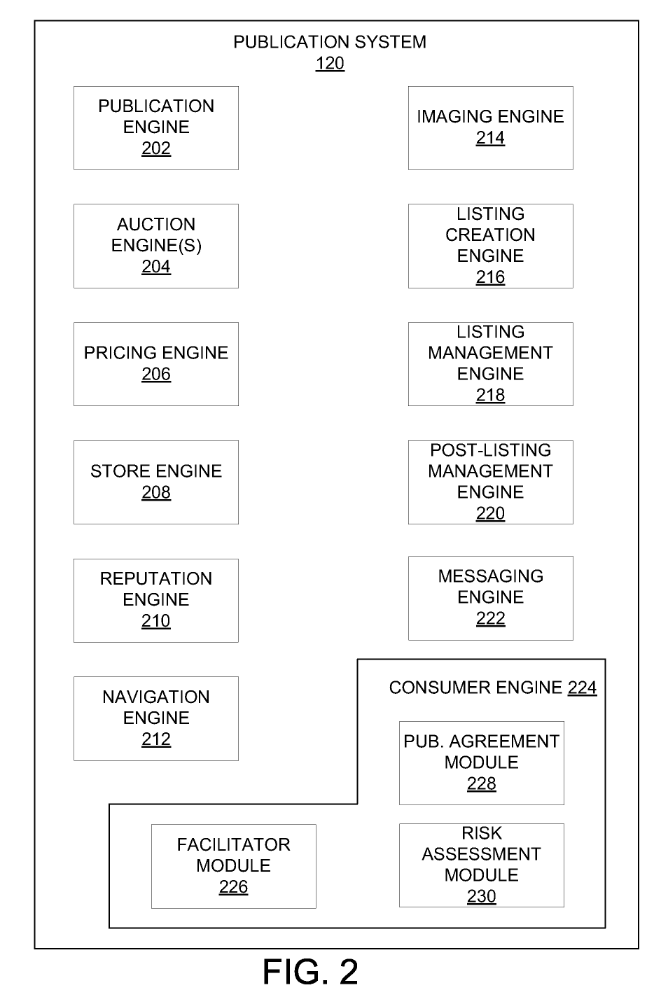

The publication system 120 provides a number of functions and services to users that access the networked system 102. For example, a user at the client device 110 desires to obtain services, information, or physical objects associated with published information (e.g., an advertisement or item listing) on the networked system 102. Obtaining the services, information, or physical objects may involve making a value transfer or payment to a provider or seller in exchange for the services, information, or physical objects. As described in more detail below, a publication system 120 and its components may provide the functionality of initiating such a value transfer on behalf of a user. The publication system 120 is discussed in more detail in connection with FIG. 2.

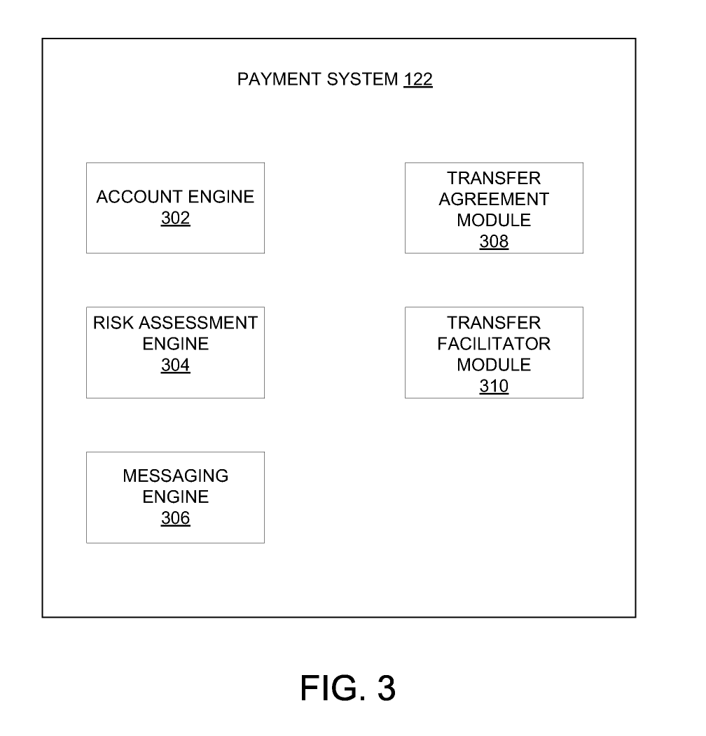

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account or credit card) for purchases of items via the network-based publication system. While the publication system 120 and the payment system 122 are shown in FIG. 1 to both form part of the networked system 102, it will be appreciated that, in alternative embodiments, the payment system 122 may form part of a payment service that is separate and distinct from the networked system 102. The payment system 122 will be discussed in more detail in connection with FIG. 3.

FIG. 1 also illustrates a third party module 128, executing on a third party server 130, as having programmatic access through the network 104 to the networked system 102 via the programmatic interface provided by the API server 114. For example, the third party module 128 may, utilizing information retrieved from the networked system 102, support one or more features or functions on a website (not shown) hosted by the third party. The third party website may, for example, provide one or more promotional, marketplace, or payment functions that are supported by the relevant applications of the networked system 102.

While the network architecture 100 of FIG. 1 employs a client-server architecture, a skilled artisan will recognize that the present disclosure is not limited to such an architecture. The network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities. Additionally, while components of the publication system 120 and the payment system 122 are shown in FIG. 1 to be implemented by two separate and distinct systems 120 and 122 in the architecture 100, it will be appreciated that, in alternative embodiments, at least some components of the publication system 120 and the payment system 122 may be implemented by common systems, machines, and/or as a node or group of associated nodes on the architecture 100.

Referring now to FIG. 2, an example block diagram illustrating multiple components that, in one embodiment, are provided within the publication system 120 is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

The networked system 102 provides a number of publishing, listing, and price-setting mechanisms whereby a seller may list (or publish information concerning) goods or services for sale, a user can express interest in or indicate a desire to purchase such goods or services, and a price can be set for a transaction pertaining to the goods or services. To this end, the publication system 120 may comprise at least one publication engine 202 and one or more auction engines 204 that support sale-format and auction-format listings and price setting mechanisms (e.g., English, Dutch, Chinese, Double, Reverse auctions, etc.). The various auction engines 204 also provide a number of features in support of these auction-format listings, such as a reserve price feature whereby a seller may specify a reserve price in connection with a listing and a proxy-bidding feature whereby a bidder may invoke automated proxy bidding.

A pricing engine 206 supports various price listing formats. One such format is a fixed-price listing format (e.g., the traditional classified advertisement-type listing or a catalogue listing). Another format comprises a buyout-type listing. Buyout-type listings (e.g., the Buy-It-Now (BIN) technology developed by eBay Inc., of San Jose, Calif.) may be offered in conjunction with auction-format listings and allow a user to purchase goods or services, which are also being offered for sale via an auction, for a fixed-price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the networked system 102 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the networked system 102 over time. Other potential trading partners may then reference the reputation for purposes of assessing credibility and trustworthiness.

Navigation of the network-based publication system may be facilitated by a navigation engine 212. For example, a search module of the navigation engine 212 enables keyword searches of item listings published via the publication system 120. In a further example, a browser module of the navigation engine 212 allows users to browse various category, catalogue, or inventory data structures according to which listings may be classified within the publication system 120. Various other navigation applications within the navigation engine 212 may be provided to supplement the searching and browsing applications.

In order to make listings available via the networked system 102 as visually informing and attractive as possible, the publication system 120 may include an imaging engine 214 that enables users to upload images for inclusion within publications (e.g., listings) and to incorporate images within viewed listings. The imaging engine 214 also receives image data from a user and utilizes the image data to identify an item depicted or described by the image data.

A listing creation engine 216 allows sellers to conveniently author publications in the example form of listings pertaining to goods or services that sellers wish to transact via the networked system 102, while a listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular user. To this end, the post-listing management engine 220 provides an interface to the reputation engine 210 allowing the seller to conveniently provide feedback regarding multiple users to the reputation engine 210.

A messaging engine 222 is responsible for the generation and delivery of messages to users of the networked system 102. Such messages include, for example, advising users regarding the status of listings and best offers (e.g., providing an acceptance notice to a user who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX). In some embodiments, the messaging engine may comprise a communication module for facilitating sending and receiving of communications including instructions, requests, and messages. Alternatively, the communication module may be located elsewhere in the publication system 120.

A consumer engine 224 manages publication system initiated value transfers. In example embodiments, the consumer engine 224 comprises a facilitator module 226, a publication agreement module 228, and a risk assessment module 230.

The facilitator module 226 may initiate a value transfer on behalf of the user (e.g., consumer or buyer) at the publication system 120. In one embodiment, the facilitator module 226 initiates the value transfer if the publication agreement validation module 228 determines that terms of a publication system initiated value transfer agreement are not violated and the risk assessment module 230 determines that the risk assessment is satisfied. In an example embodiment, the facilitator module 226 may initiate the value transfer by directing an application interface call (e.g., via a communication module of the publication system 120) to an engine or module operated by the payment system 122. It may be noted that the communication between the publication system 120 and the payment system 122 is not limited to any particular communication or interface protocol.

The publication agreement validation module 228 may also be used to establish agreements for the publication system initiated value transfers, and to subsequently determine, in response to a request, whether terms of the agreement permit a publication system initiated value transfer. The publication agreement validation module 228 may interact with a user, via one or more user interfaces (e.g., via one or more web pages over the network 104) to facilitate defining terms of the agreement. In alternative embodiments, the agreement terms may be defined at the payment system 122. It should be noted that any number of agreements may be generated for a user. For example, the user may have one agreement that is applicable for mobile devices and a second agreement that is applicable for non-mobile devices.

The risk assessment engine 230 implements fraud detection and prevention mechanisms to reduce the occurrence of fraud within the publication system 120. For example, the risk assessment engine 230 may verify e-mail addresses, MAC addresses, mailing addresses, card security codes (e.g., CCID) of credit cards, IP addresses, or history of user transactions for a registered user.

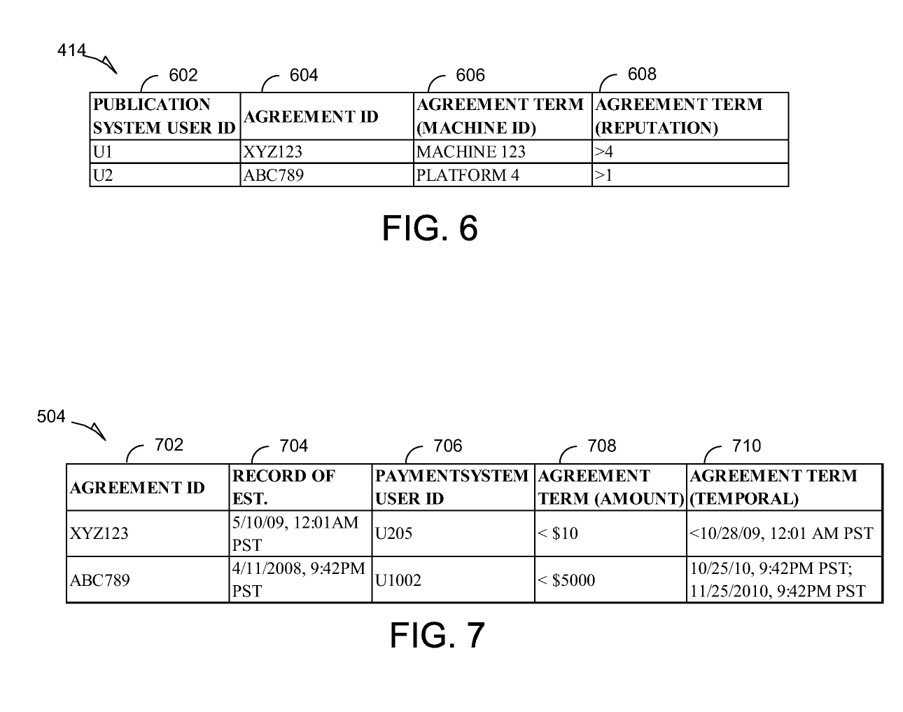

The agreement between a user and the payment system 122 may include terms that define conditions under which the publication system 120 may initiate a value transfer on behalf of the user. Examples of agreement terms are discussed in more detail with respect to FIG. 6 and FIG. 7. Agreement terms may be defined by the user, the publication systems 120, the payment system 122, or any combination thereof.

Although the various components of the publication system 120 have been defined in terms of a variety of individual modules and engines, a skilled artisan will recognize that many of the items can be combined or organized in other ways. Furthermore, not all components of the publication system 120 have been included in FIG. 2. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

Referring now to FIG. 3, the payment system 122 is shown in more detail. The payment system 122 provides a number of payment services and functions to users. In example embodiments, the payment system 122 may comprise an account engine 302, a risk assessment engine 304, a messaging engine 306, a transfer agreement module 308, and a transfer facilitator module 310.

The account engine 302 manages user accounts with the payment system 122. By establishing an account with the payment system 122, the user may use the payment system 122 to make payments or otherwise transfer value. In one embodiment, an account may be established by the user providing contact information as well one or more funding options to fund their account. Funding options may include, for example, credit cards, wire transfers, and bank accounts.

The risk assessment engine 304 implements fraud detection and prevention mechanisms to reduce the occurrence of fraud within the payment system 122. For example, the risk assessment engine 304 may verify e-mail addresses, MAC addresses, mailing addresses, card security codes (e.g., CCID) of credit cards, IP addresses, or history of user transactions for a registered user.

The messaging engine 306 is responsible for the generation and delivery of messages between the payment system 122 and users of the payment system 122. For example, the messaging engine 306 may generate and send a confirmation e-mail to a user or seller when a value transfer is performed. In some embodiments, the messaging engine may comprise a communication module for facilitating sending and receiving of communications including messages. Alternatively, the communication module may be located elsewhere in the payment system 122.

The transfer agreement module 308 may be used to manage agreements for publication system initiated value transfers, and to subsequently determine whether the publication system 120 is authorized to initiate a transfer of a unit of value on behalf of a user and complete the transfer. In example embodiments, the transfer agreement module 308 generates the agreement and defines terms of the agreement for a user. It should be noted that any number of agreements may be generated for a user. For example, the user may have one agreement that is applicable for mobile devices and a second agreement that is applicable for non-mobile devices

The transfer facilitator module 310 reviews the terms of an agreement to determine if all conditions are met for a publication system initiated value transfer. The transfer facilitator module 310 further interacts with the risk assessment engine 304 to perform a risk assessment of the publication system initiated value transfer. If all conditions are met and the risk level is below a pre-defined criteria (e.g., a threshold), then the transfer facilitator module 310 transfers a designated unit of value (e.g., money, points) from one or more sources. For example, the sources may include coupons, gift certificates, gift cards, pre-funded accounts, and payment instruments (e.g., credit cards). For example, the payment system 122 may transfer a particular dollar amount from a user's account to a seller's account on the payment system 122.

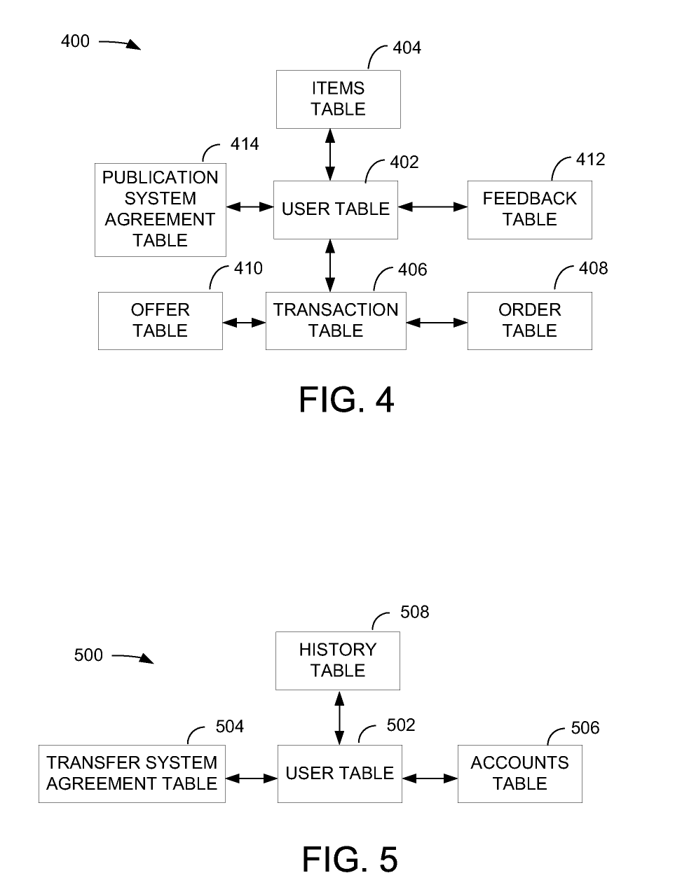

FIG. 4 is a high-level entity-relationship diagram, illustrating various example tables 400 that may be utilized by functional modules of the publication system 120, in accordance with an example embodiment. The tables 400 may be maintained within one or more of the databases 126 and be accessed by components of the publication system 120. It should be noted that the information stored in the tables illustrated in FIG. 4 may be arranged in other manners (e.g., matrix of information, hash tables).

The tables may comprise a user table 402 that contains a record for each registered user of the publication system 120. The user table 402 may, in one embodiment, include a user identifier, a MAC address, a mailing address, card security codes (e.g., CCID) for registered credit or debit cards, and an identification of a payment system (e.g., payment system 122) associated with each such registered user.

The tables 400 may further comprise an items table 404 in which are maintained item records for goods and services that are available to be, or have been, transacted via the publication system 120. Each item record within the items table 404 may be linked to one or more user records within the user table 402, so as to associate a seller and one or more actual or potential users with each item record in the item table 404.

A transaction table 406 contains a record for each transaction pertaining to items for which records exist within the items table 404. The transactions may include, for example, a purchase or sale transaction.

An order table 408 may be populated with order records, each order record being associated with an order. An order may be an instruction to buy, sell, or supply an item. Thus, each order may be associated with one or more transactions for which records exist within the transaction table 406.

Offer records within an offer table 410 each relate to an offer received by the publication system 120. The offer may be in connection with a selling-format listing supported by a selling operation (e.g., performed via the auction engine 204).

A feedback table 412 may be utilized by one or more reputation engines 210, in one example embodiment, to construct and maintain reputation information concerning sellers, buyers, or any other users associated with the publication system 120. These reputations may be made available and published to potential trading partners. The reputation information allows a user, for example through feedback provided by one or more other transaction partners, to establish a reputation within the networked system 102 over time. Other potential trading partners may then reference the reputation for purposes of assessing credibility and trustworthiness.

The publication system agreement table 414 may include records related to an agreement for payments initiated by the publication system 120. The publication system agreement table 414 may be accessed by the publication system facilitator module 226 or the publication agreement module 228.

FIG. 5 is a further high-level entity-relationship diagram, illustrating various tables 500 that may be utilized by functional modules of the payment system 122, in accordance with an example embodiment. The tables 500 may be maintained within one or more of the databases 126 and be accessed by the components of the payment systems 122. In one embodiment, the tables 500 comprise a user table 502, a transfer system agreement table 404, an accounts table 506, and a history table 508.

The user table 502 may contain a record for each registered user of the payment system 122. The user table 502 may include a user identifier, a MAC address, a mailing address, or card security codes (e.g., CCID) for registered credit or debit cards associated with each registered user.

The transfer system agreement table 504 may include records related to an agreement for payments initiated by the payment system 122. The transfer system agreement table 504 may be accessed by the transfer facilitator module 310 or the transfer agreement module 308.

The accounts table 506 may maintain information for one or more accounts for each user. The account may serve to receive or send units of value for an account holder. In example embodiments, the accounts are accounts specific to the payment system 122.

A history table 508 may maintain a history of payment transactions to which a user has been a party. The payment transactions may include both receipt of value to an account and payment of value from an account of a user.

FIG. 6 illustrates an example publication system agreement table 414, in accordance with an example embodiment. The publication system agreement table 414 may be stored in one of the databases 126 or be stored in a dedicated database of the publication system 120. The example publication system agreement table 414 is shown to include a publication system user identifier (ID) column 602, agreement identifier (ID) column 604, and one or more agreement terms. These agreement terms define criteria that should be met at the publication system in order to initiate the value transfer. In the present example, the agreement terms include a machine ID shown in an agreement term (machine ID) column 606 and a reputation threshold shown in an agreement term (reputation) column 608. Alternative embodiments may contemplate the use of any number and types of agreement terms.

The publication system user ID column 602 provides a list of user identifiers for registered users of the publication system 120. For example, the first row under the publication system user ID column 602 includes an identifier “U1.” A user may submit “U1” to the publication system 120 in order to identify the user (e.g., log in) to the publication system 120.

In an example embodiment, the agreement ID column 604 uniquely identifies an agreement authorizing the publication system 120 to initiate a value transfer on behalf of the user identified in the publication system user ID column 602. In some example embodiments, the publication system 120 uses the agreement identifier as an index to agreement terms to determine whether or not the agreement terms permit proceeding with a publication system initiated value transfer. If the terms are satisfied, then the publication system 120 will forward a request for value transfer to the payment system 122.

The agreement term (machine ID) column 606 lists information to identify a machine (e.g., client device 110) from which a user has submitted a request to the publication system 120. In some example embodiments, the publication system 120 may be authorized to initiate a transfer of value only if the user's request for the transfer originated with a particular machine indicated by the machine ID listed in the agreement term (machine ID) column 606. A user request from an unrecognized machine may result in a payment denial message to the user from the publication system 120.

The agreement term (reputation) column 608 lists a threshold reputation value associated with a seller. In an example embodiment, a reputation value for a seller may be defined based on feedback from other registered users. For instance, the seller may be rated on a scale of one to five on various characteristics such as reliability, timeliness, professionalism, or any other characteristics that may be useful to a user in making a decision about transacting with a seller. In the first row of the agreement term (reputation) column 608, a reputation value of greater than four (i.e., >4) must be associated with a seller in order for the agreement term to not be violated. If the term is violated, than the publication system initiated value transfer may be denied.

It is noted that agreement terms are not limited to those shown in FIG. 6. Any number and types of agreement terms may be established and enforced. For example, a PIN number may be associated with each publication system user ID, which needs to match an entered PIN in order for the publication system initiated value transfer to be allowed.

FIG. 7 is a table illustrating an example value transfer system agreement table 504, in accordance with an example embodiment. The example transfer system agreement table 504 includes an agreement ID column 702, a record of establishment date column 704, a payment system user ID column 706, and agreement term columns. These agreement terms define criteria that should be met at the payment system in order to facilitate the value transfer. In the present example, the agreement terms include an amount term shown in an agreement term (amount) column 708 and a time term shown in an agreement term (temporal) column 710. Other agreement terms may include, for example, specific shipping addresses.

The agreement ID column 702 includes an agreement identifier that is the same or similar to that of the agreement ID column 604 of FIG. 6. The agreement ID column 702 uniquely identifies the agreement authorizing the publication system 120 to initiate a value transfer on behalf of the user. In some example embodiments, the payment system 122 uses the agreement ID as an index to agreement terms to determine whether or not the agreement terms permit proceeding with a publication system initiated value transfer. In an example embodiment, a user may be a registered user of the publication system 120 as well as the payment system 122. Thus, both the publication system 120 and the payment system 122 may keep records (e.g., in a table) of the agreement identifier.

The record of establishment column 704 includes, for each agreement ID, a time quantity (e.g., date and/or time) associated with the establishment of the agreement relating to publication system initiated value transfers.

The payment system user id column 706 includes a unique identifier for users of the value transfer system 106. In some embodiments, the user identifier may be the same for both the publication system 120 and the payment system 122.

The agreement term (amount) column 708 may include, for each agreement identifier, a maximum or minimum amount of units of value for which a publication system 120 is authorized to initiate a transfer. For example, an initiation request, from the publication system 120, including the agreement identifier “XYZ123” and including a request to transfer more $10 may be denied by the payment system 120 based on the agreement amount term provided. While dollar values are shown in the agreement term (amount) column 708, any unit of value may be contemplated. For example, the unit of value may be loyalty points.

The agreement term (temporal) column 710 provides a maximum or minimum time quantity (e.g., date and/or time) associated with authorized value transfer initiated by the publication system 120. In some example embodiments, a maximum time quantity, characterized by the less-than sign “<” may define a period of time between a date and time of establishment in the record of establishment column 704 and a maximum date and time term in the agreement term (temporal) column 710. In an example embodiment, the publication system may be authorized to initiate value transfers only during the period of time between the date and time of establishment and the maximum date and time term in the agreement term (temporal) column 710.

In some example embodiments, a minimum time quantity, characterized by the greater than sign “>” may indicate a time quantity after which initiation of value transfers by the publication system 120 may be authorized. In an example embodiment, a payment system 122 may return a notification of denial to the publication system 120 if an attempt is made to initiate a value transfer prior to the minimum time quantity. As shown, an agreement identifier found in the second row of the agreement ID column 702 (i.e., ABC789) is associated with both a minimum time quantity and a maximum time quantity. In such an embodiment, initiation of a transfer may not be made before Oct. 25, 2010 at 9:42 PM Pacific standard time, and may not be made after Nov. 25, 2010 at 9:42 PM Pacific standard time.

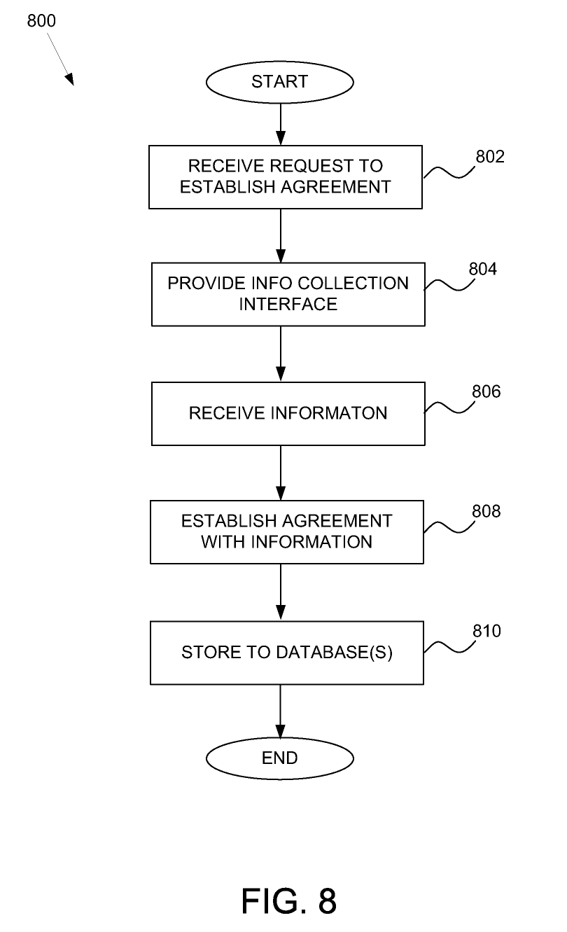

FIG. 8 is a flow diagram illustrating an example method 800 for establishing an agreement to allow the publication system 120 to initiate a value transfer on behalf of a user, in accordance with an example embodiment. In some embodiments, a user may establish the agreement through the publication agreement module 228 or the transfer agreement module 308.

At operation 802, a request to establish the agreement is received. In example embodiments, a user (e.g., buyer), via the client device 110, sends the request to enable publication system initiated payments. The request may be received by the publication agreement module 228 of the publication system 120 or the transfer agreement module 308 of the payment system 122 depending on whether the user is accessing the publication system 120 or the payment system 122 when the request is sent. For example, if the user is logged into and accessing the publication system 120, then the request is received by the publication agreement module 228.

At operation 804, an information collection interface is provided to the user by the publication agreement module 228 or the transfer agreement module 308. In an example embodiment, one or more web pages (not shown) may be presented to the user. The information collected may include, for example, a user identifier, contact information, and financial information about the user (e.g., credit card account, banking account). Some of the information may already be stored with the publication system 120 or the payment system 122. For example, the user's contact information may already be stored with the publication system 120, and the user may only need to confirm the information (e.g., the information may be pre-populated by the interface). Web pages may also present terms of agreement usage to the user.

Additionally, the user provides agreement terms in operation 804. These agreement terms define criteria that should be met at the publication system in order to initiate a value transfer or at the payment system in order to facilitate the value transfer. Examples of agreement terms include shipping addresses, reputation thresholds, amount thresholds, temporal boundaries, PINs, and machine identifiers.

The information is received in operation 806 and triggers the establishment of the agreement that authorizes the publication system 120 to initiate transfers on behalf of the user in operation 808. In one embodiment, an agreement identifier for the agreement may be issued to the user. Furthermore, terms of the agreement may be identified based on the collected information (e.g., user may provide an amount limitation). The agreement identifier may be issued by the publication agreement module 228 or the transfer agreement module 308. Furthermore, if the publication agreement module 228 initiates the agreement generation, the publication agreement module 228 may provide the received information to the transfer agreement module 308 for generation of the agreement.

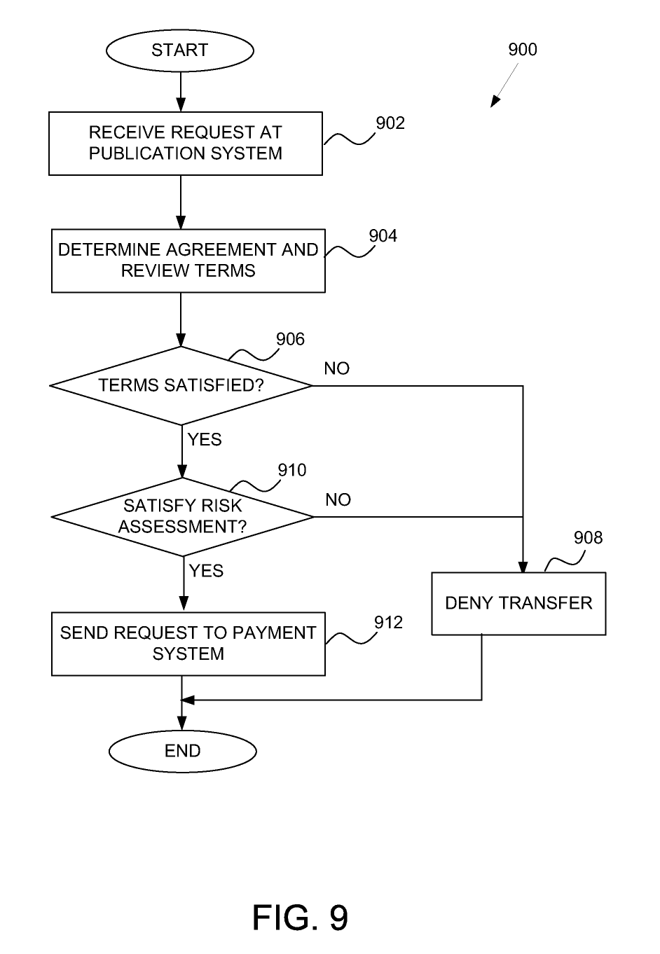

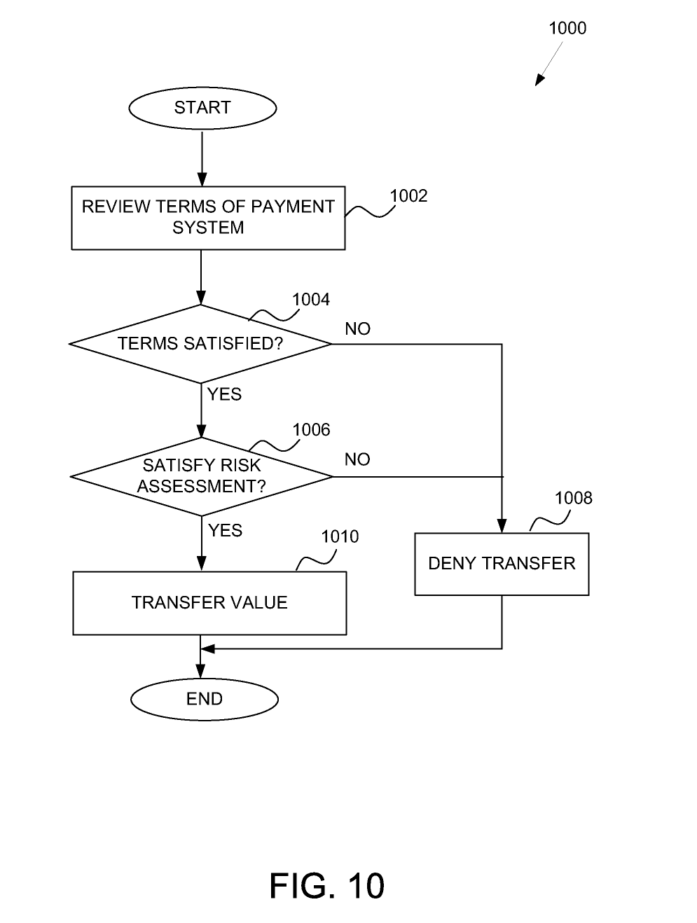

In operation 810, the agreement is stored to one or more databases. In various embodiments, the agreement may be stored, accessed, or enforced by one or both of the publication system 120 and the payment system 122. Enforcement of the agreement by the publication system 120 and the payment system 122 is described in more detail with respect to FIG. 9 and FIG. 10.

FIG. 9 is a flow diagram illustrating an example method 900 for initiating value transfer at the publication system 120, in accordance with an example embodiment. At operation 902, a request for the publication system 120 to initiate value transfer on behalf of a user is received by a communication module of the publication system 120. For some example embodiments, a user at the client device 110 (e.g., a consumer or buyer) may access an online publication presented by the publication system 120 and decide to purchase an item advertised in the online publication. The user may indicate a desire to purchase the item by interacting with a web page presenting the online publication. For example, the user may click on a “place bid” button to place a bid for an item, a “make best offer” button to make a price offer to the seller, or a “buy it now” button to buy the item for a posted selling price.

When indicating the desire to purchase the item, the user may indicate a desire for the publication system 120 to initiate a value transfer associated with the purchase. The user may provide the indication by selecting the option on an item purchase page. Referring to the request for a publication system 120 initiated payment, the user may indicate the desire to make a payment under various price setting formats and payment processes. For some example embodiments, the user may make a payment directly from the online publication by checking a checkbox presented next to a “place bid” button, a “make best offer” button, and/or a “buy it now” button stating, “complete checkout if I win.”

In one embodiment, the user may provide an agreement identifier that identifies a previously established agreement for publication system initiated payments. In an example embodiment, the user may provide the agreement identifier during a sign-in or login process or during the indication to purchase (e.g., on a purchase page). In other embodiments, the user may provide a PIN or any other form of security information that will verify the identity of the user to the publication system 120 or to the payment system 122.

Alternatively or additionally, a user may start a payment process for one or more items that a user has previously purchased by selecting a “pay now” button on a web page that lists the previously purchased items. The publication system 120 may then present the user with a “confirm payment” button page that the user may click to request the publication system 120 to initiate the payment. Alternatively, the selection of the “pay now” button alone may trigger a request for the publication system initiated payment to be made.

For some example embodiments, a user may purchase an item from a widget embedded in a web page served by a third party (e.g., a party other than the publication system 120). In an example embodiment, an item may be presented via widget and a user who has established an agreement for publication system initiated payments may elect to purchase the item and complete a transaction from the widget itself. Communication between the widget and the publication system 120 in the background (e.g., typically without presentation to the user) may enable this functionality.

In some example embodiments, the user may elect for publication system 120 initiated payments when the user has pre-ordered an item. For example, if a user has searched for an item but cannot find a match for their requirements, the user may register a pre-order for the item with the publication system 120. Registering the pre-order may include requesting a publication system 120 initiated payment for an item when the item that satisfies the user's requirements becomes available in the publication system 120.

At operation 904, the previously established agreement between the user and the publication system 120 or payment system 122 is identified. The agreement may be identified using an agreement identifier, a publication system user identifier, or any other identifier to identify the agreement. For example, the user may be logged into the publication system 120. Using the user's publication system user ID, a lookup may be performed in the publication system agreement table 414 in response to the request. In example embodiments, the publication agreement module 228 may begin a process of identifying an established agreement and determining whether the requested payment should be initiated.

The terms of the agreement are reviewed to determine if all the terms are satisfied at the publication system 120 at operation 906. For example, the user may be assigned the publication system identifier “U1” of column 602 in FIG. 6 and be a party to the agreement “XYZ123” of column 604. If the publication agreement module 228 determines that the request was submitted from “machine 123” and that the seller originating the online publication presented by the publication system 120 has a reputation in column 608 that is greater than “4”, the publication agreement module 228 concludes that the agreement terms enforced by the publication system 120 are not violated. If the terms are not satisfied, then the transfer is denied in operation 908.

If the terms are satisfied, then risk assessment determination is performed in operation 910. For example, the risk assessment module 230 may review or verify one or more of an e-mail address, MAC address, mailing address, card security code (e.g., CCID) of a credit card for a registered user, IP address of the user, and history of user transactions (e.g., to detect past fraudulent transactions).

If the risk assessment is satisfied, a request to transfer value is sent by the publication system 120 to a communication module at the payment system 122 in operation 912. For example, the facilitator module 226 of the consumer engine 224 may initiate the transfer of value from the user to one or more sellers by sending the request to the payment system 122 to execute the transfer.

However, if the risk assessment is not satisfied, the value transfer request initiated by the publication system 120 is denied in operation 908. If the publication system initiated value transfer is denied, a communication is provided to the user to inform the user of the denial. The user may then use other means to pay for their purchase (e.g., log into the payment system 122 and manually initiate the payment).

FIG. 10 is a flow diagram illustrating an example method 1000 for initiating value transfer at the payment system 122, in accordance with an example embodiment. Upon receiving the request from the publication system 120, at operation 1002, the terms are reviewed at the payment system 122 to determine if the value transfer may be performed. In example embodiments, the request from the publication system facilitator module 226 may be received by either the transfer agreement module 308 or the transfer facilitator module 310, which may use the agreement identifier (e.g., agreement identifier XYZ123) of column 702 to evaluate whether the agreement terms are met for the particular transaction. For example, if the user seeks to make a payment of $5 on Sep. 1, 2009, the agreement terms will be met since the agreement terms require paying less then $10 prior to Oct. 28, 2009.

If the transfer facilitator module 310 determines that the agreement terms enforced by the payment system 122 have been met at operation 1004, a further risk assessment is performed at the payment system 122 in operation 1006. However, if the terms are not satisfied at operation 1004, then the transfer is denied by the payment system 122 in operation 1008.

If the risk assessment is satisfied at operation 1006, then the transfer agreement module 308 may signal the transfer facilitator module 310 to execute the transfer of value from an account held by the user to one or more accounts held by the one or more sellers at operation 1010. Conversely, if the risk assessment is not satisfied in operation 1006, then the transfer is denied in operation 1008.

Through practice of the techniques disclosed herein, a user may be exposed to a fewer number of web pages and service providers during the process of purchasing an item. For example, a previously established agreement to allow publication system initiated payments may permit a user to avoid being re-directed to a web page hosted by a networked payment system since the user may complete the payment through the publication system web site.

As a result of limiting the user's interactions to the publication system, a publication system may control the amount of information a user is exposed to, introduce fewer steps to complete the payment and thus reduce network traffic, and uncomplicate the user's experience. Furthermore, the publication system 120 may keep the user's attention on the publication system 120 (e.g., on marketplace web pages), which may result in the user making additional purchases via the network-based publication system and consequently may increase publication system income.

In addition, decoupling the network-based publication system from the networked payment system during the payment process may simplify software development since changes to the network-based publication system ay not require changes to the software of the networked payment system in order to maintain compatibility between the two. Likewise, changes to networked payment system software may not require changes to the network-based publication system software.

A machine and its features are described below. The machine may be representative of the machines describe with respect to FIG. 1 including the client devices 110 and 112, and the machines operating the systems and modules of the publication system 120 and the payment system 122.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

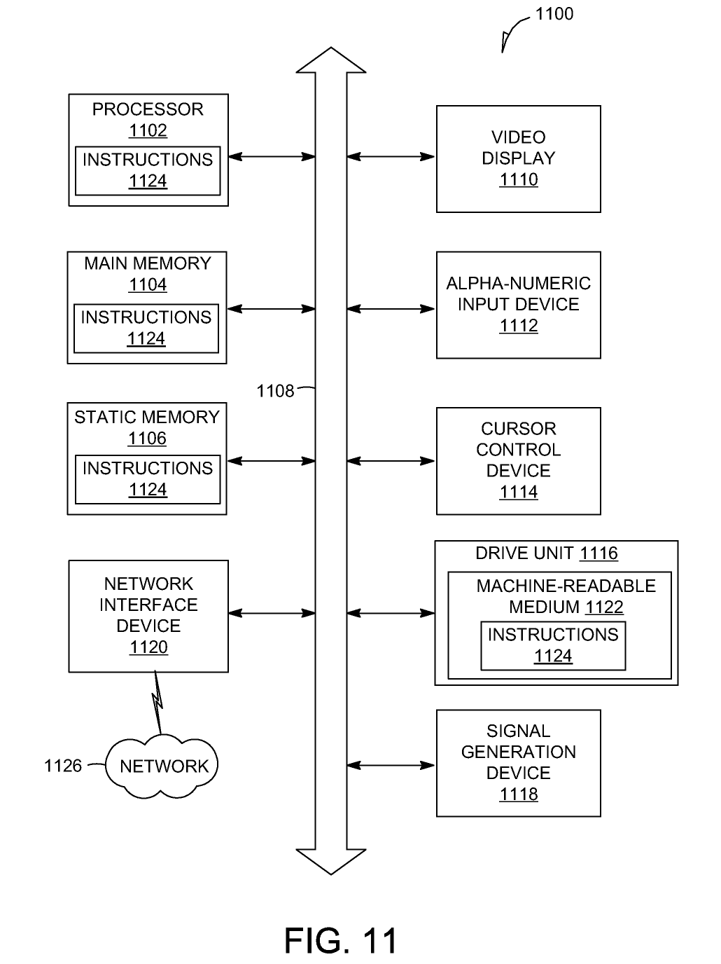

With reference to FIG. 11, an example embodiment extends to a machine in the example form of a computer system 1100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 may include a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). In example embodiments, the computer system 1100 also includes one or more of an alpha-numeric input device 1112 (e.g., a keyboard), a user interface (UI) navigation device or cursor control device 1114 (e.g., a mouse), a disk drive unit 1116, a signal generation device 1118 (e.g., a speaker), and a network interface device 1120.

### Machine-Readable Storage Medium

The disk drive unit 1116 includes a machine-readable storage medium 1122 on which is stored one or more sets of instructions 1124 and data structures (e.g., software instructions) embodying or used by any one or more of the methodologies or functions described herein. The instructions 1124 may also reside, completely or at least partially, within the main memory 1104 or within the processor 1102 during execution thereof by the computer system 1100, the main memory 1104 and the processor 1102 also constituting machine-readable storage media.

While the machine-readable storage medium 1122 is shown in an example embodiment to be a single medium, the term “machine-readable storage medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium via the network interface device 1120 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a request to initiate a value transfer from a publication system on behalf of a user, the publication system allowing one or more providers to offer items to the user;
identifying a previously established agreement between the user and a payment system, the previously established agreement authorizing the publication system to initiate the value transfer on behalf of the user;
determining, using one or more processors, whether one or more agreement terms of the previously established agreement are satisfied; and
based on the determining, transferring a value from an account associated with the user to at least one further account.

2. The method of claim 1, further comprising determining if a risk assessment is satisfied prior to transferring the value.

3. The method of claim 1, wherein the determining comprises determining whether a unit of value of the request satisfies a specific threshold value.

4. The method of claim 3, wherein the unit of value is a monetary amount.

5. The method of claim 3, wherein the unit of value is based on points or miles.

6. The method of claim 1, wherein the determining comprises determining whether the request is within a threshold time period.

7. The method of claim 1, wherein the determining comprises determining if the request is from a specific machine associated with the user.

8. The method of claim 1, wherein the determining comprises determining if the request meets a threshold feedback rating, the feedback rating being an opinion about a provider of the item, based on feedback from one or more other users.

9. The method of claim 1, wherein the determining further comprises sending a request to perform the value transfer from the publication system to the payment system if the agreement terms at the publication system are satisfied.

10. The method of claim 1, wherein the determining further comprises facilitating the value transfer if the agreements terms at the payment system are satisfied.

11. A system comprising:
a communication module to receive a request to initiate a value transfer from a publication system on behalf of a user, the publication system allowing one or more providers to offer items to the user;
at least one agreement module to identify a previously established agreement between the user and a payment system, the previously established agreement authorizing the publication system to initiate the value transfer on behalf of the user, and to determine whether one or more agreement terms of the previously established agreement are satisfied; and
a facilitator module to transfer, based on the determining, a value from an account associated with the user to at least one further account.

12. The system of claim 11, further comprising a risk assessment module to determine if a risk assessment is satisfied prior to the transfer of value.

13. The system of claim 11, wherein the communication module and facilitator module are associated with the publication system, and the facilitator module submits a transfer request to the payment system to initiate the value transfer based on the determining.

14. The system of claim 11, wherein the communication module and the facilitator module are associated with the payment system, and the facilitator module transfers a value from the account associated with the user to the at least one further account based on the determining.

15. The system of claim 11, wherein the at least one agreement module comprises a publication agreement module to determine compliance with the one or more agreement terms, wherein the compliance authorizes the publication system to initiate the value transfer.

16. The system of claim 11, wherein the at least one agreement module comprises a transfer agreement module to determine compliance with the one or more agreement terms, wherein the compliance triggers the facilitator module to transfer the value from the account associated with the user to the at least one further account.

17. A machine-readable storage medium in communication with at least one processor, the machine-readable storage medium storing instructions which, when executed by the at least one processor, provides a method comprising:
receiving a request to initiate a value transfer from a publication system on behalf of a user, the publication system allowing one or more providers to offer items to the user;
identifying a previously established agreement between the user and a payment system, the previously established agreement authorizing the publication system to initiate the value transfer on behalf of the user;
determining, using one or more processors, whether one or more agreement terms of the previously established agreement are satisfied; and
based on the determining, transferring a value from an account associated with the user to at least one further account.

18. The machine-readable storage medium of claim 17, wherein the method further comprises determining if a risk assessment is satisfied prior to transferring the value.

19. The machine-readable storage medium of claim 17, wherein the determining further comprises sending a request to perform the value transfer from the publication system to the payment system if the agreement terms at the publication system are satisfied.

20. The machine-readable storage medium of claim 17, wherein the determining further comprises facilitating the value transfer if the agreements terms at the payment system are satisfied.
